(19) United States
(12) Patent Application Publication
(10) Pub. No.: US 2011/0047461 A1
(43) Pub. Date: Feb. 24, 2011

(54) System and Method for Desktop Management

(76) Inventor: Jeffrey M. Bargmann, Ann Arbor, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 12/860,109

(22) Filed: Aug. 20, 2010

Related U.S. Application Data
(60) Provisional application No. 61/235,754, filed on Aug. 21, 2009.

(51) Int. Cl. G06F 3/048; G06F 3/01

(52) U.S. Cl. 715/702; 715/765

(57) ABSTRACT

A system and method includes displaying a desktop for a computing system, the desktop having icons. In response to a single action being performed, the method makes the icons non-viewable on the desktop when the icons are initially viewable, and makes the icons viewable on the desktop when the icons are initially non-viewable.

### CROSS REFERENCE TO RELATED APPLICATION

This application claims priority to U.S. Provisional Patent Application No. 61/235,754 filed on Aug. 21, 2009, titled “QUICK-HIDE FEATURE FOR COMPUTER DESKTOP ICONS,” to Jeffrey M. Bargmann, which is incorporated herein by reference in its entirety.

### TECHNICAL FIELD

The subject invention relates to software for computers, and more specifically to software for managing computer screen desktop displays.

### BACKGROUND

Computer screens commonly display a graphic user interface known as a desktop. The desktop often has a decorative background and icons set against the background, where the icons represent buttons that, when clicked or activated, can open a given program. Computer software makers have provided software that enables people to arrange icons on the desktop in some desirable way. Computer software makers have also provided procedures for allowing people to remove icons from the desktop, and for allowing people to add icons to the desktop. However, these procedures are unduly cumbersome, and they typically involve several steps and a significant amount of time to execute the steps.

Consequently, there is a need to reduce the amount of clutter on a desktop and allow for an efficient use of desktop icons.

### BRIEF SUMMARY

The invention in its various manifestations improves on the state of the art by providing a feature to toggle between one state where the desktop icons are hidden, and another state where they re-appear. According to one manifestation of the invention, there is an improved computer system that includes a storage device having desktop software of the type capable of displaying a desktop on a screen where the desktop uses icons representing computer programs; a processor interrelated with the storage device and being capable of running the desktop software; a screen interrelated with the processor and being capable of displaying the desktop software and the icons; an icon toggling input device interrelated with the processor for manipulating the desktop software; and icon toggling software interrelated with the desktop software and being adapted to hide at least one of the icons in response to an input from the icon toggling input device.

According to another manifestation of the invention, there is a method for using an input device to manipulate computer desktop icons to temporarily hide them on the desktop. The method includes the steps of manipulating an input device to send a first input to the computer; processing the first input with the computer; and thereby causing the computer to hide the icon from the desktop.

Other manifestations of the invention are possible. The invention thus provides a number of simple ways to toggle the icons on the desktop between a visible and active state, and an invisible and inactive state. This is something novel that encourages desktop use.

### BRIEF DESCRIPTION OF THE DRAWINGS

The features and inventive aspects will become more apparent upon reading the following detailed description, claims, and drawings, of which the following is a brief description:

FIG. 1 is a flow diagram of a quick-hide feature for computer desktop icons.

FIG. 2 is an example of a computer desktop with open space.

FIG. 3 is an example of a computer desktop with icons shown.

FIG. 4 is an example of hiding computer desktop icons according to an embodiment of the quick-hide feature.

FIG. 5 is an example of un-hiding computer desktop icons according to an embodiment of the quick-hide feature.

FIG. 6 is a flow diagram of the starting up of a system and method for computer desktop management that includes a quick-hide feature.

FIG. 7 is a flow diagram detailing how quick-hide functionality may be integrated with the Windows® environment.

FIG. 8 is a flow diagram of an example trigger, including a double-click and empty space trigger.

FIG. 9 is an example of a desktop screen shot illustrating another embodiment of the quick-hide feature.

FIG. 10 is an example of a desktop screen shot illustrating another embodiment of the quick-hide feature.

### DETAILED DESCRIPTION

Referring now to the drawings, illustrative embodiments are shown in detail. Although the drawings represent the embodiments, the drawings are not necessarily to scale and certain features may be exaggerated to better illustrate and explain novel aspects of an embodiment. Further, the embodiments described herein are not intended to be exhaustive or otherwise limit or restrict the claims to the precise form and configuration shown in the drawings and disclosed in the following detailed description.

This application claims priority to U.S. Provisional Patent Application No. 61/235,754 filed on Aug. 21, 2009, titled “QUICK-HIDE FEATURE FOR COMPUTER DESKTOP ICONS,” to Jeffrey M. Bargmann, which is incorporated herein by reference in its entirety.

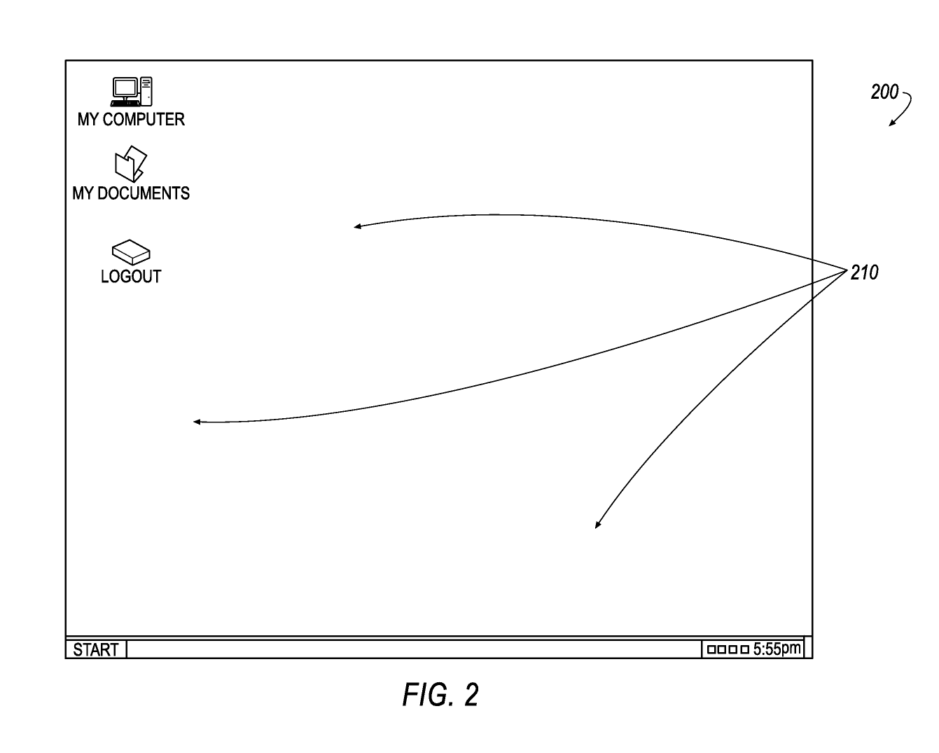

A system and method for computer desktop management includes a quick-hide feature that adds functionality to a computer desktop (see FIGS. 2-5) wherein the desktop's icons can be quickly hidden and re-shown, for example, by double-clicking blank space on the desktop (see FIG. 2).

The double-clicking (e.g., by using a mouse) may be an example of a single action being performed to trigger the quick-hide feature. The single action may also include touch-screen technology that may allow a user's finger to tap the desktop, a stylus to tap the desktop. The single action may also include activating a specific part of the screen (e.g., a corner, an edge, a target, a button, etc.). The single action can also be a prolonged press of a key (e.g, holding the “h” button for a predetermined amount of time).

Alternatively, a non-user-related single input could be the predetermined amount of time. An example of a non user-related single input may be when an application is in use for a predetermined amount of time, the desktop icons may be hidden automatically when the predetermined amount of time has elapsed. This may be useful, for example, if a user is word processing and the desktop will automatically organize itself by making the icons non-visible.

The quick-hide feature encourages use of desktop icons, because users can quickly hide the icons when they are not desired, but still retrieve them quickly when they need them. Due to the lack of this feature on current modern computers, often users will not have any icons (or other objects such as clocks/gadgets, for that matter) on their desktop in order to avoid obscuring their wallpaper, or having a sense of “messiness” on their desktop.

The quick-hide feature includes an instant quick-access nature in which it provides the ability to hide/show the desktop icons. While there exists functionality to hide the desktop icons in computer systems, it is cumbersome and time consuming. For example, in Windows® as well as similar desktop environments—namely right clicking the desktop, navigating a menu and checking/un-checking “show desktop icons.” However, the obscurity and inaccessibility of this procedure causes it to not be discovered by many users, and not be used by many users due to its inconvenience. There is nothing quick and easy about the existing procedure. In contrast, the new quick-hide feature operates under the Fitts' Law principle of “the single most accessible target in a mouse-driven computer system is the target directly underneath where the mouse cursor is currently located” to provide instant liberating access to the desktop's icons. (See http://en.wikipedia.org/wiki/Fitts's_law). According to Fitts' Law, the present invention is superior to the pre-existing procedure described above because the invention requires substantially less motion and less time to effect the operation. With some embodiments of the present invention, the user may not need to move the cursor at all: the user may simply need to double-click to toggle the disappearance/reappearance of the icons. However, in the pre-existing menu-driven way, the user needs to move the cursor to open a new menu, navigate through the menu, click to initiate certain operations within the menu, and then close the menu. There are several ways to achieve the present invention and its goal from a technical standpoint; detailed below is one of these ways, with some alternatives presented as well.

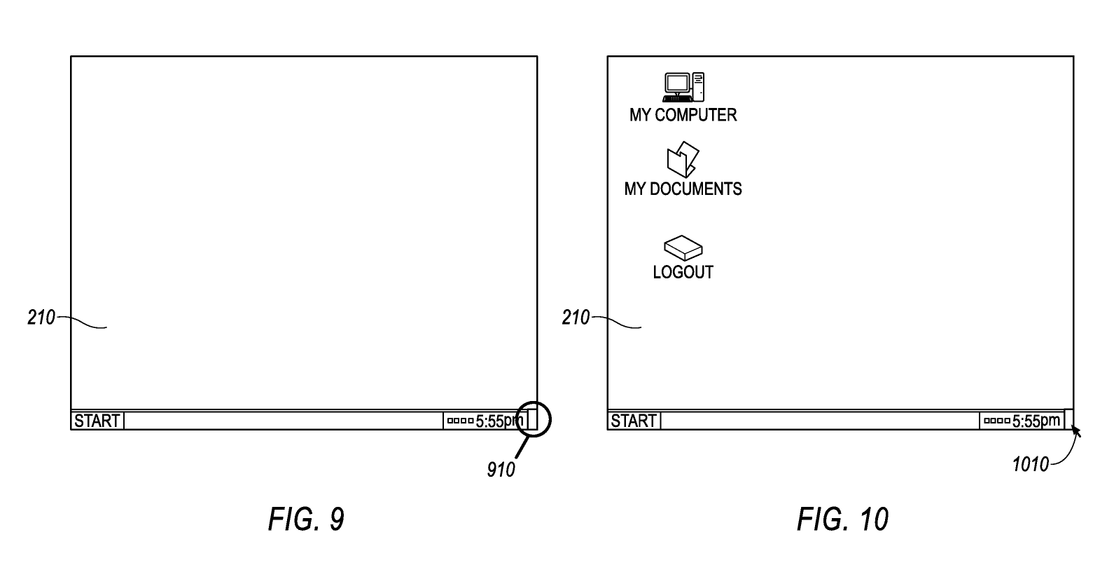

Optionally, the user can specify individual icons to always leave as visible even during the “quick-hide.” Optionally, the transition from visible/hidden and back can have some sort of transition-visual-effect to better relay to the user that the icons are disappearing. This could include such things as a “fade-in/fade-out” (as demonstrated below) or other common graphical effects that relay the same meaning. Hot-keys (depressing a specific keyboard-combination) can be configured to toggle the visibility of desktop icons. E.g. when the “escape” key (ESC) is pressed on the desktop, the desktop icons' visibility will toggle. Icons may also be configured to automatically hide or show when the mouse moves to a specific area of the screen for a short period of time, including 1) a specific corner or edge of the screen or 2) over a visible “target” that shows on a portion of the screen (see FIG. 9 at 910 and FIG. 10 at 1010). Other events can trigger the hiding/showing of desktop icons, including 1) after a given period of inactivity; 2) after the desktop is activated/de-activated; 3) after an object is invoked on it; or 4) some other singular input gesture, such as a swipe, press, or prolonged press.

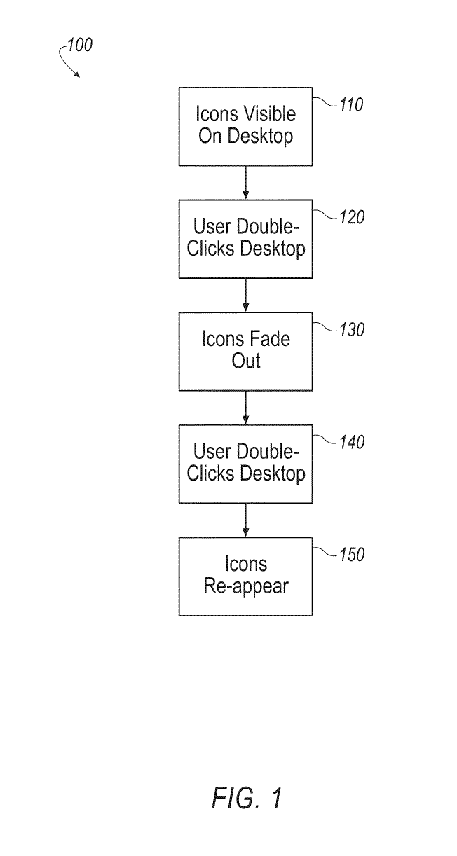

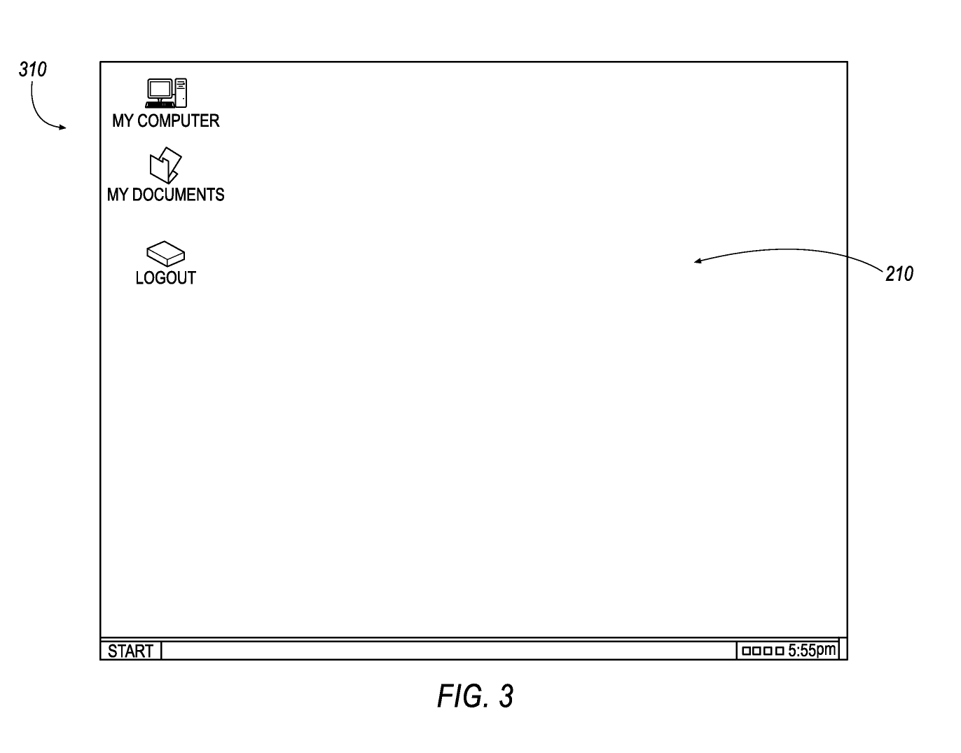

FIG. 1 is a flow diagram 100 of a quick-hide feature for computer desktop icons. The process starts at step 110 where the icons 310 are visible to the user on their desktop 210 (see also FIG. 3).

At step 120, the user double-clicks the desktop 210. The double clicking may be, for example, done by a mouse or a fingertip (e.g., when using a touch-screen computer device).

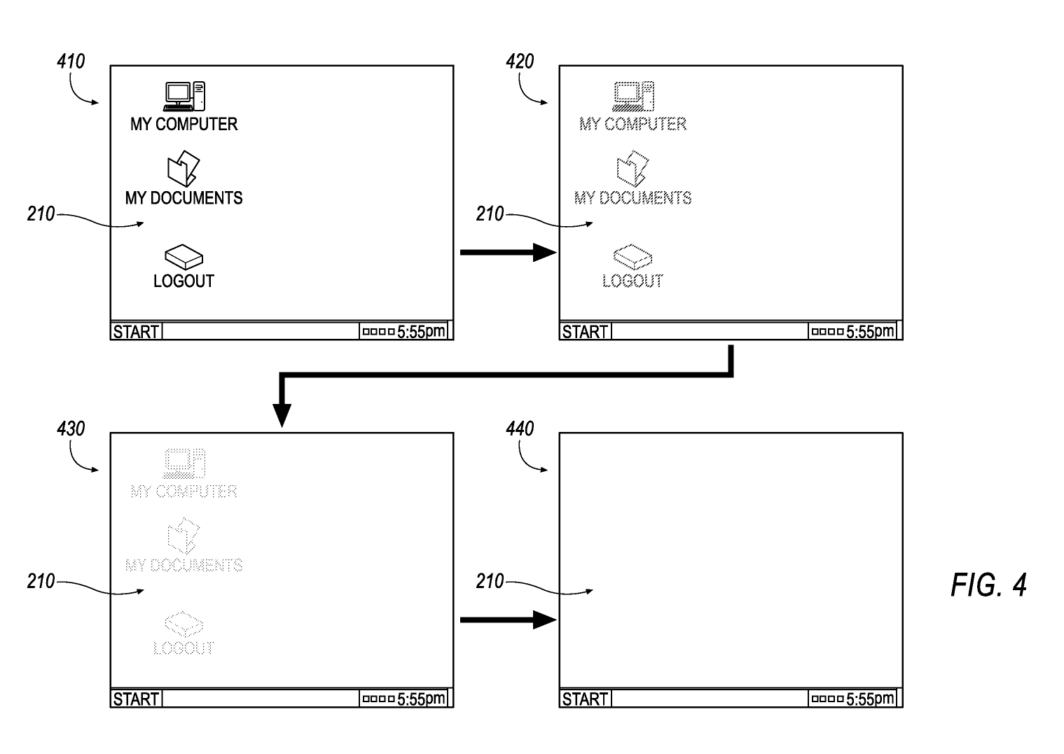

At step 130, the icons 310 on the desktop 210 fade out of view. In this process, the icons may fade away over time, disappear nearly instantly, or transition to other forms of transparency (e.g., partly transparent where most of the icon is visible). At this stage, and in the examples described below, the icons are no longer visible to the user and are not cluttering the screen. The process is shown in FIG. 4, where at step 410 the icons (near 410) are shown on the desktop 210 as fully opaque. Next, in step 420, the icons appear slightly transparent. In step 430, the icons are mostly transparent. In step 440, the icons have disappeared from the desktop 210.

At step 140, the user may double-click the desktop 210 to initiate the system in showing the desktop icons.

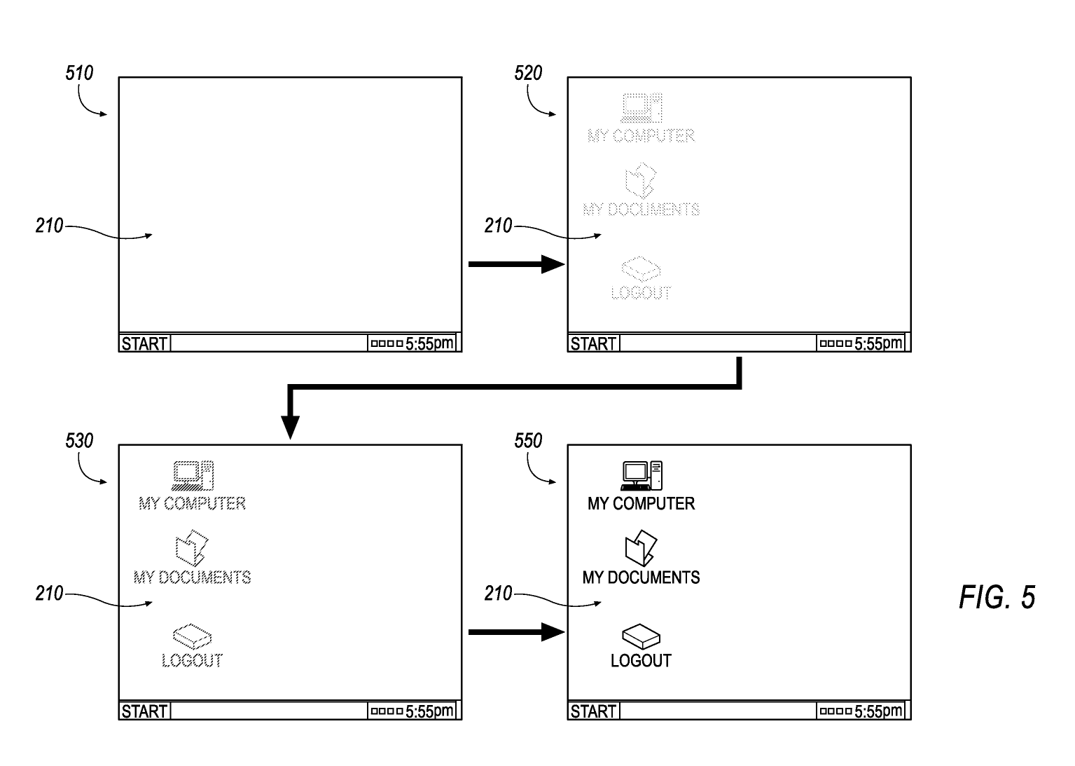

At step 150, the icons re-appear on the desktop. This process is shown in detail in FIG. 5. In the first step 510, the desktop 210 does not show the icons. In step 520, the icons begin to appear (see the location near 520) as mostly transparent. In step 530, the icons are less transparent (e.g., more opaque) than in step 520. In the final step 540, the icons are fully opaque and available for use by the user.

FIG. 2 shows a simple view of a desktop environment. The open space on the desktop is shown by arrows 210. This space is available for double-clicking by the user. In some cases, the computer system may be a touch-screen, such as is employed on mobile devices. However, as discussed herein, the desktop may include desktop computer systems and mobile computer systems. Moreover, the action of double-clicking may be made by a mouse button, a fingertip when a touch-type device is used, or a gesture (e.g., as is used with a mouse or fingertip).

FIG. 3 shows a basic desktop 210 with icons 310. The user can click or double-click the icons, for example, to launch programs or open folders. However, the icons may have other functions that may be assigned by the operating system or the user.

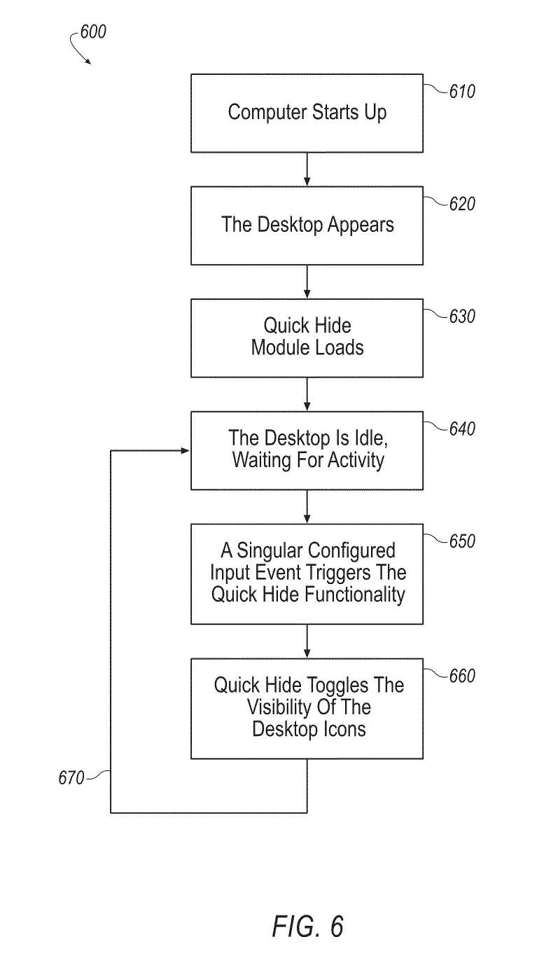

FIG. 6 is a flow diagram 610 of the starting up of a system and method for computer desktop management that includes a quick-hide feature. In general, the flow diagram shows the starting up and hiding/showing of the desktop icons. This diagram demonstrates the quick-hide functionality as a 3rd-party add-on to an original manufacturer's desktop environment program. If added directly into the desktop environment by the original creator of the environment, people of ordinary skill in the art of user interface development understand that the resulting flow diagram would be functionally similar in nature.

In step 610, the computer starts up. This may be, for example, when the computer is turned on and the operating system loads.

In step 620, the desktop 210 appears (see also FIG. 3). When the operating system loads the user interface, the desktop 210 and other functionality are shown and are visible.

In step 630, the quick-hide module loads.

In step 640, the desktop is idle and waits for activity.

In step 650, the singular configured input event triggers the quick-hide functionality. The singular configured input event trigger may be one of several configurable single-motion actions trigged by the user, such as a double-click, mouse movement, pressing a hotkey, an inactivity-period, or other kind of input, as described in the description herein.

In step 660, the quick-hide toggles the visibility of the desktop icons. The process then repeats 670 by transitioning control back to step 640.

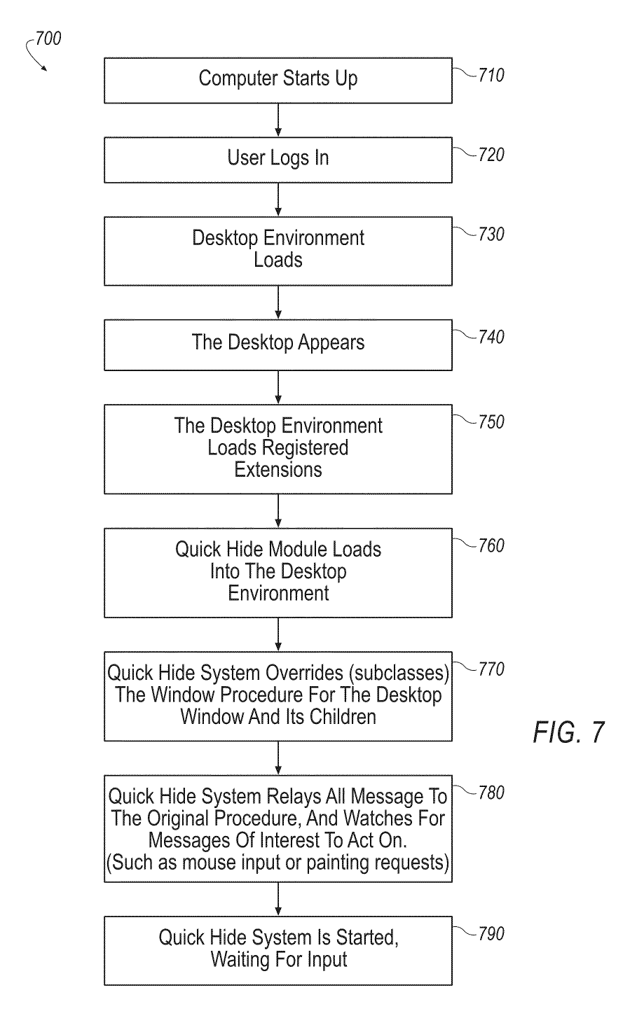

FIG. 7 is a flow diagram 700 detailing how quick-hide functionality may be integrated with the Windows® environment. While the diagram shown in FIG. 7 was designed with the Microsoft Windows® environment in mind, people of ordinary skill in the art of user interface development understand that this same process could be applied to other desktop environments with adjustments to conform to that platform's requirements.

In step 710, the computer starts up. This may be an event, such as a “booting” of a computer or coming out of a sleep mode for a mobile device that may not keep all applications running when hibernating.

In step 720, the user logs in. The user may login by a user-name and password, or they may be automatically logged in if the system is configured to do so.

In step 730, the desktop environment loads. The desktop environment may load after the computer system loads some or all of the basic software modules. The desktop may not be available to the user until after the system is finished or nearly finished loading.

In step 740, the desktop 210 appears (see also FIG. 2). The desktop may be considered the area used for placing objects such as icons or files. As discussed herein, a desktop may be used as a generic description for an area or region in a graphical user interface configured for user interaction. A typical desktop includes free space that is available for the user or system to configure. Moreover, the desktop may be the “home” location in a multi-windowed operating system.

In step 750, the desktop environment loads registered extensions. The extensions, or extension handlers, include software that extends or modifies the functionality of certain programs or the operating systems.

In step 760, the quick-hide module loads into the desktop environment.

In step 770, the quick-hide module overrides (subclasses) the window procedure for the desktop window and its children (i.e., parents and children in object-oriented programming). The subclassing and overriding features may be implemented differently based on the system and language used. However, the subclassing and overriding typically function to allow another implementation to override certain functionality of the parent class. In this way, the parent class need not be replaced, but the particular functions that would be needed for the quick-hide system may be accessed, replaced, or augmented with the quick-hide module.

In step 780, the quick-hide system relays all messages to the original procedure, and watches for messages of interest to act on. These messages of interest may include a mouse input or a screen-painting request.

In step 790, the quick-hide system is started and waits for an input.

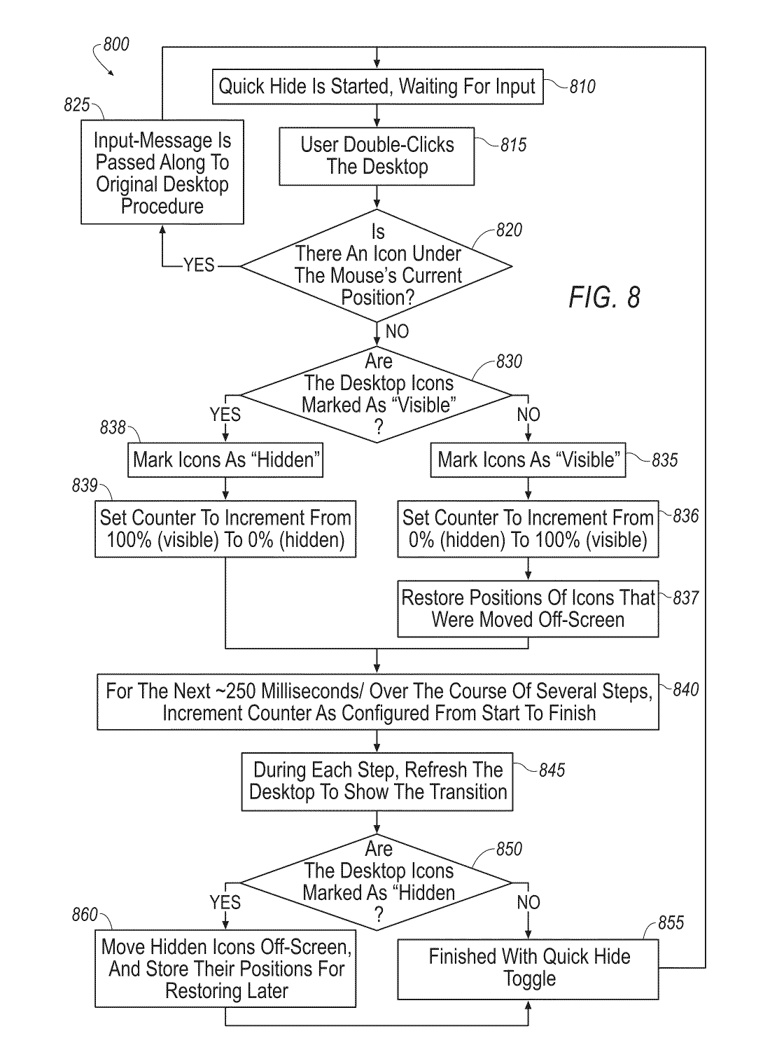

FIG. 8 is a flow diagram 800 of an example trigger, including a double-click and empty space trigger. The flow diagram 880 represents an example of a “double-click empty space” trigger for hiding/showing the desktop icons. People of ordinary skill in the art of user interface development would understand that variations of this flow diagram would be functionally similar if prepared for other forms of single-motion triggers such as hot-button keys (e.g. the ESC key) as well as touch-screen inputs.

In step 810, the quick-hide system is started and waits for an input.

In step 815, a user double-clicks the desktop.

In step 820, the quick-hide system checks whether there is an icon under the mouse's current position at the time of the double-click. If there is not an icon under the current position, control proceeds to step 830. If there is an icon under the current position, control proceeds to step 825.

In step 825, the input-message is passed along to the original desktop procedure and control proceeds to step 810.

In step 830, the quick-hide system determines whether the desktop icons are marked as visible. If the desktop icons are marked as visible, control proceeds to step 838. If the desktop icons are not marked as visible, control proceeds to step 835.

In step 835, the desktop icons are marked as visible. The marking process may be used, for example, by the quick-hide system to indicate the current status of the icons as visible and hidden.

In step 836, a counter is set to increment from 0% (hidden) to 100% (visible).

In step 837, the icon's positions are restored to where they were located before being moved off the desktop (e.g., moved off the screen).

In step 838, the icons are marked as “hidden”.

In step 839, the counter is set to increment from 100% (visible) to 0% (hidden).

In step 840, for the next (approximately) 250 milliseconds, or over the course of several steps, the increment counter works through each step from start to finish.

In step 845, during each step of the increment counter, the desktop is refreshed to show the transition of the icons from hidden to visible, or visible to hidden.

In step 850, the quick-hide system determines if the desktop icons are marked as hidden. If the desktop icons are marked as hidden, then control proceeds to step 860. If the icons are not marked as hidden, then control proceeds to step 855.

In step 855, the quick-hide toggle (e.g., the transition from hidden to visible or visible to hidden) is complete and control proceeds to step 810.

In step 860, the hidden icons are moved off the desktop (e.g., moved off the screen) and their positions are stored for later use (e.g., as in step 837).

In addition to the flow diagrams and descriptions above, additional information is provided herein (see below) that one of skill in the art may use to create the quick-hide system in a Windows® environment. Although the methods described herein are specific for the Windows® environment starting with Windows XP® through Windows 7®, the concepts apply to all desktop environments because they have equivalent methods and structures for handling the desktop icons and the user inputs. In addition, there are many ways to achieve the quick-hide functionality and the detailed methods described herein are exemplary of a fully featured quick-hide system.

To create a new shell-extension program module a programmer may first create a new Win32 DLL project using Visual Studio by Microsoft. This is a common procedure for people of ordinary skill in the art of Win32 and COM programming. The programmer may then set up this DLL-module to act as a “context menu shell extension,” to facilitate loading it into the desktop. This is a common procedure well documented by Microsoft. People of skill in the art of Win32 and COM (Component Object Model) programming will appreciate how to accomplish this. This process is covered more deeply in the technical details described below, but is not necessary to the functionality of the quick-hide system. For example, creating a shell extension is shown and described in detail at:
http://msdn.microsoft.com/en-us/library/cc144067(VS.85).aspx

The programmer may then configure a shell-extension to load with Explorer on startup. In technical terms, this may be done by having a shell extension expose the “lRunnableTask” interface, and then registering in Explorer's “SharedTaskScheduler” local-machine registry key with the extension's full globally unique identifier (“GUID”) as the value name, and plain text-name as the value. Upon being loaded into Explorer's process space, the shell extension should call LoadLibrary on itself in order to ensure it stays loaded. This method is an example of an operating system feature that can be used towards the goal of hiding the desktop icons, but is simply one of many methods available to load with the desktop.

To override the drawing of icons on the desktop, the “paint” procedure for the desktop may be intercepted. This may be called “subclassing,” depending on the operating system and software languages used. Intercepting and subclassing are procedures well documented by Microsoft. Examples may be found at:
http://msdn.microsoft.com/en-us/library/ms633500(VS.85).aspx
http://msdn.microsoft.com/en-us/library/bb773183(VS.85).aspx

Upon receiving paint notifications: If an icon should be completely hidden, signal to skip that icon's paint procedure entirely. This is done by overriding the behavior of the “WM-NOTIFY” message received by the “SHELLDLL-DefView” window of the desktop on Windows®. When the notification code is “NM-CUSTOMDRAW,” and the drawing-stage specified by the NMLVCUSTOMDRAW parameter is “CDDS-ITEMPREPAINT,” “CDRF-SKIPDEFAULT” should be returned to signal no more drawing is requested.

For the WM-NOTIFY window-message, an example of this may be found at:
http://msdn.microsoft.com/en-us/library/bb775583(S.85).aspx

For the M-CUSTOMDRAW notification, an example of this may be found at:
http://msdn.microsoft.com/en-us/library/bb774865(VS.85).aspx

For the NMLVCUSTOMDRAW parameter, an example of this may be found at:
http://msdn.microsoft.com/en-us/library/bb774778(VS.85).aspx

Upon receiving paint notifications: If an icon should be partially-hidden (e.g. it is visually-transitioning from visible to hidden or vice-versa), before the icon paints, capture the current image of the desktop where the icon will be. After the icon paints, draw that previous image back on top of where the icon drew itself, in a faded-manner. Drawing the background back on top of the icon will simulate the icon being drawn in a faded manner. This is done by overriding the behavior of the “WM-NOTIFY” message received by the “SHELLDLL-DefView” window of the desktop on Windows®. When the notification code is “NM-CUSTOMDRAW,” and the drawing-stage specified by the NMLVCUSTOMDRAW parameter is “CDDS-ITEMPREPAINT,” one should capture the icon area specified by the device-context & drawrectangle given by the message parameters to a memory-device-context using BitBlt. During “CDDS-ITEMPOSTPAINT,” that memory-devicecontext should be drawn back to the device-context specified by the message parameters in a faded manner using AlphaBlend.

While a creative use of drawing procedures, the functionalities described here are well documented by Microsoft.

An example of the WM-NOTIFY window-message can be found at:
http://msdn.microsoft.com/en-us/library/bb775583(VS.85).aspx

An example of the NM-CUSTOMDRAW notification can be found at:
http://msdn.microsoft.com/en-us/library/bb774865(VS.85).aspx

An example of the NMLVCUSTOMDRAW parameter can be found at:
http://msdn.microsoft.com/en-us/library/bb774778(VS.85).aspx

An example of creating and using a memory-device-contexts can be found at:
http://msdn.microsoft.com/en-us/library/dd145049(VS.85).aspx

An example of the BitBlt Win32 function can be found at:
http://msdn.microsoft.com/en-us/library/dd183370(VS.85).aspx

An example of the AlphaBlend Win32 function can be found at:
http://msdn.microsoft.com/en-us/library/dd183351(VS.85).aspx

Move “hidden” icons off-screen, to prevent them from being clicked on. When made “hidden,” “hidden” icons should be moved off-screen. Once visibility has been restored, the icons may be restored to their previous positions. This procedure may be required, for example, to intercept the icons' drawing only hides them from view. They are still clickable. To be completely hidden from interaction, the icons may be temporarily moved off-screen.

An example of the LVM-GETITEMCOUNT message can be found at:
http://msdn.microsoft.com/en-us/library/bb761044(VS.85).aspx

An example of the LVM-GETITEMPOSITION message can be found at:
http://msdn.microsoft.com/en-us/library/bb761048(VS.85).aspx

An example of the LVM-SETITEMPOSITION message can be found at:
http://msdn.microsoft.com/en-us/library/bb761192(VS.85).aspx

To respond to a mouse-input, the “mouse button double-click” messages may be intercepted when they are sent to the desktop. In technical terms, this is called “subclassing.”

An example of the finding the window to subclass can be found at:
http://msdn.microsoft.com/en-us/library/ms633500(VS.85).aspx

An example of the performing subclassing can be found at:
http://msdn.microsoft.com/en-us/library/bb773183(VS.85).aspx

Upon receiving a “mouse button double-click” message, toggle the variable the program is using to keep track of the visibility of the desktop icons from 100% to 096, or back from 0% to 100% as appropriate. In technical terms, it is the WM-LBUTTONDBLCLK message that may be intercepted. The desktop should then have its visuals refreshed after this procedure. Refreshing a window is a simple method well-documented by Microsoft.

An example of the Redrawwindow Win32 function:
http://msdn.microsoft.com/en-us/library/dd162911(VS.85).aspx

The system may also be configured to respond to other kinds of single-motion triggers. In an example, if so configured, upon receiving a “mouse move” message, if the mouse is currently over a spot of configured interest, keep track of the mouse's position and setlreset a timer for a period of time in the short future (example: 1 second). If the mouse is still in the same region after the configured time period elapses, adjust the desktop icons to be hidden or visible, as configured as-appropriate.

Places of configured interest could include such locations as a corner of the screen, edge of the screen, or over a visual target that has been placed on the screen for the purpose of showing or hiding the desktop icons.

In an example, if so configured, immediately upon receiving any input whatsoever, adjust the desktop icons to be visible.

In an example, if so configured, upon receiving a message from the operating system indicating the user has flicked the screen with their finger or gestured in some other routine configured manner (applicable to “touch” enabled systems only), adjust the desktop icons to be hidden or visible, as-configured/as-appropriate.

In an example, if so configured, watch for inactivity-periods on the desktop, and hide icons after periods of inactivity. Upon receiving any input, setlreset a timer for a period of time in the near-future (example: 10 seconds). If no additional activity has been received in that period of time, adjust the desktop icons to be hidden.

In an example, if so configured, upon receiving notification from the operating system that the desktop's surface has been de-activated, after a short period of time elapses (example: 2 seconds) if the desktop is still not active, adjust the desktop icons to be hidden.

In an example, if so configured, upon receiving a “button pressed” message, start a timer for a period of time in the near future (example: 2 seconds). If the time period passes and the mouse button has not significantly moved but is still pressed, toggle the visibility of the desktop icons. (This applies particularly for touch-enabled systems.)

In an example, if so configured, after any item on the desktop is invoked (e.g. folder is opened, etc), hide the desktop icons. (This could be achieved using the variety of ways detailed above, including by detecting a double-click, watching for inactivity, watching for deactivation, or a combination of these.

In an example, if so configured, upon starting up the program should register the hotkey configured for icon hiding and/or showing with the system. Upon receiving notification from the system that those key[s] have been pressed, the visibility of the desktop icons should be adjusted accordingly.

In an example of loading the program, where the steps were done as described above, the module should be a shell extension for Windows® Explorer. Register this module with the system, restart the computer, and the program will be loaded. Alternatively, a loader-program may run on startup and externally-loads the module into explorer (called “injection,” also detailed below).

Best-practice-method to create a program that achieves the highlighted functionality (Note to reader, MSDN is the official documentation library provided by Microsoft itself, and Codeproject is a top user-article-based resource for programmers around the world. These resources enable people of ordinary skill in Win32 and COM development to perform documented/routine tasks they are unsure on how to (but are capable to) achieve. Use this information in conjunction with the overview above.)

An example of to setup the system is to create a dynamic-linking-library (“dll”) program module using Visual Studio. In an example, using one of several possible methods, load the module created into the Windows® Explorer (i.e., explorer.exe's process space).

In an example, the “CreateRemoteThread/WriteProcessMemory” live injection method may be used. Examples may be found at:
http://www.codeproject.com/KB/threads/winspy.aspx
http://www.codeproject.com/KB/threads/completeinject.aspx
http://www.codeproject.com/KB/winsdk/Remote.aspx

If this method is chosen, it may be created as a separate program, and placed in the “startup” folder as to execute on startup. In an example, the “Load as shell extension” method may be used. This is not necessary, but may improve reliability during regular-use.

In an example, the dll may be a standard Windows® shell extension dll. An example of can be found at:
http://www.codeproject.com/KB/shell/shellextguide1.aspx

Set “disable process isolation” for the shell extension by using set “DisableProcessIsolation”=dword:00000001 for the shell extension in registry. An example of can be found at:
http://msdn.microsoft.com/en-us/library/cc144131(VS.85).aspx

Use one of several options to get loaded with explorer, such as SharedTaskScheduler. In an example, make an entry in the registry key “HKEY˜LOCAL˜MACHINE\SOFTWARE\Microsoft\Windows\CurrentVersion\Explorer\SharedTaskScheduler” with the extension's CLSID as the value name (such as “{1984DD45-52CF-49cd-AB77-18F378FEA264)”), and the display-name of the extension as the value (such as “Example ShellExtension”).

With either method used, call “LoadLibrary” by passing in a path name once it has been loaded (in the dll's “DLLMain”/process-attached function). This will ensure that it stays loaded.

Program the module to, upon being loaded in to Windows® Explorer, locate and subclass the Window Procedure for the desktop window.

(Layman's note: a Window Procedure is the instructions behind a window. “Subclassing” layers on an additional layer of instruction on to a window, and is programmatically legal on Windows® if the code resides in the same process as the window being subclassed.)

An example of subclassing a window can be found at:
http://msdn.microsoft.com/en-us/library/bb773183(VS.85).aspx

In an example, in Windows® XP (with Active Desktop disabled) and on Vista, the desktop window's root window goes by the classname “Program” and title “Program Manager.” Its single child is of class “SHELLDLL-DefView,” which has a single child of class “SysListView32.” In most cases this is true for Windows® 7 as well, but in certain circumstances the parent of the desktop may be a “WorkerW class window instead, and thus the desktop listview may be more thoroughly searched for.

The desktop's root window can be located via: FindWindow(“Progman,” “Program Manager”); Then the Microsoft tool “Spy++,” included with all version of Visual Studio, can be used to easily locate the desktop window and its children. Both the “SHELLDLL-DefView” and “SysListView32” child Windows® of the desktop may be subclassed. To verify the module is loaded into Explorer and not another process, verifying that the exe of the current process is “explorer.exe.” Alternatively, the GetWindowThreadProcessId can be used to verify the current process owns the desktop window, once it is found. Examples can be found at:
http://msdn.microsoft.com/en-us/library/ms683197(VS.85).aspx
http://msdn.microsoft.com/en-us/library/ms633522(VS.85).aspx

In an example of reacting to a mouse input, and triggering the visibility-toggle, the WM-LBUTTONDBLCLK notification may be intercepted and sent to the desktop's “SysListView32” child window. The system can detect if any icon is currently under the cursor, by sending a LVM-HITTEST message to the ListView window with the cursor's current relative-coordinates. If no icon is under the cursor, start a thread to transition a visibility variable from 100% (1.0) to 0% (0.0), or back from 0% to 100% as necessary. During each major step, refresh the desktop window to update the visuals as seen fit. An example regarding the LVM-HITTEST may be found at:
http://msdn.microsoft.com/en-us/library/bb761099(VS.85).aspx

Turning now to an example of moving icons off-screen while hidden, in the toggle-thread, while moving from 100% to 0% or back from 0% to 100%, the icons' positions should be moved to offscreen whenever at 0% visibility, and restored to on-screen for any visibility level above 0%. Use LVM-GETITEMCOUNT to get a count of all items on the desktop, then use LVM-GETITEMPOSITION and LVM-SETITEMPOSITION to aid in storing the original position of/moving each icon. This step may be necessary because the below-detailed “painting manipulation” only prevents the icons from being painted. They still exist there even though they are no longer visible. Therefore, in order to avoid the user accidentally click them while hidden, they may be temporarily moved off screen. Desktop auto-arrange may be disabled to achieve this. The user can take care of this by right clicking the desktop and unchecking “Auto arrange icons.”

Now turning to an example of the blocking drawing of icons and drawing icons at variable transparency levels. The WM-NOTIFY messages sent to the desktop child window of class “SHELLDLL-DefView” may be intercepted. During NM-CUSTOMDRAW notifications from its child listview, return CDRF-NOTIFYITEMDRAW during the CDDS-PREPAINT draw stage in order to be notified of the drawing of each icon. During CDDS-ITEMPREPAINT, if the icon being drawn should be at 0% visibility, immediately return CDRF-SKIPDEFAULT in order to cancel any drawing for that icon at that time. If the icon should be drawn at some level between 0 and 100%, during the CDDS-ITEMPREPAINT stage the part of the desktop that that icon occupies should be copied from the device context specified by the notification's NMLVCUSTOMDRAW structure using BitBlt to an offscreen buffer, created using GetDC/CreateCompatibleDC/CreateCompatibleBitmap. Upon reaching the CDDS-ITEMPOSTPAINT stage in a subsequent WM-NOTIFYINM-CUSTOMDRAW message, this image should be drawn back to the screen using the AlphaBlend function, with the desired inverse opacity level.

Now turning to an example of responding to other kinds of single-motion triggers. In an example, if so configured, watch for the user hovering over a specific area of configured interest. To do so, watch WM-MOUSEMOVE messages processed by the desktop. If the position of the cursor indicates that it is near such a spot of configured interest (such as an edge of the screen, corner of the screen, or over a target displayed on or near the desktop), set a timer for a short period of time (example: 1000 ms) using the “SetTimer” Win32 API. When the timer becomes invoked, check the cursor's position to see if it is still over the same region. If it is, toggle the desktop to hide or show the desktop icons as configured/as appropriate.

In an example, if so configured, watch for any WM-MOUSEMOVE, or WM-LBUTTONDOWN messages, as configured. If any inputs of interest are received, toggle the desktop icons to be visible.

In an example, if so configured, watch for “gesture”/“flick” messages generated by the operating system. On Windows® XP this can include such messages as WM-APPCOMMAND with commands of APPCOMMAND-BROWSER-BACKWARD or APPCOMMAND-BROWSER-FORWARD received by the desktop window, indicating flick-leftlflick-right. On Windows® 7 this could include such gestures as defined by the WM-TOUCH message. Upon receiving a message from the operating system indicating the user has triggered the appropriate configured gesture, adjust the desktop icons to be hidden or visible, as-configured/as appropriate.

An example of the WM-APPCOMMAND message may be found at:
http://msdn.microsoft.com/en-us/library/ms646275(VS.85).aspx

An example of the “Touch” APIs/messages on Windows 7 may be found at:
http://msdn.microsoft.com/en-us/library/dd562197(VS.85).aspx

In an example, if so configured, watch for inactivity-periods on the desktop. Upon receiving any input, such as WM-MOUSEMOVE/WM-LBUTTONDOWN/etc or WM-KEYDOWNlWM-KEYUP messages, call the Win32 API “SetTimer” to setlreset a timer for a period in the configured near-future (example: 5 seconds). When the timer elapses, end the timer, and then adjust the desktop icons to be hidden.

In an example, if so configured, hide the desktop icons after being deactivated. Upon receiving a WM-ACTIVATE message indicating that the window has been deactivated, set a timer using the SetTimer Win32 API to a period in the very near future (example: 2 seconds). If a WM-ACTIVATE message is received indicating the window has been activated, call the KillTimer Win32 API to deactivate the timer. If the timer elapses (the period of time passed without getting activated again), then you will know the desktop was not immediately re-activated after being deactivated, and the desktop icons should be hidden, so do so. An example of the WM-ACTIVATE notification may be found at:
http://msdn.microsoft.com/en-us/library/ms646274(VS.85).aspx

In an example, if so configured, the desktop can be shown/hidden via hotkey. If detecting just a single keystroke, watch for WM-KEYDOWN messages processed by the desktop, and react when an appropriate one is received. Otherwise, hotkeys can be registered with the system using the RegisterHotKey function, and notifications of its pressing are delivered via WM-HOTKEY messages. Upon receiving such a message, hide or show the desktop as configured/as appropriate.

An example of the RegisterHotKey Win32 API may be found at:
http://msdn.microsoft.com/en-us/library/ms646309(VS.85).aspx

An example of the WM-HOTKEY notification may be found at:
http://msdn.microsoft.com/en-us/library/ms646279(VS.85).aspx

In an alternative method that may be simplified but does not allow for exclusions or transition-effects, like above: create a dll, and program it to load into explorer.exe and subclass the desktop windows in order to intercept mouse messages for the desktop. When double-click on blank space is detected on the “Progman” or “SysListView32” windows, send a WM-COMMAND message of command “7402” to the “Progman” class window. This action causes Windows to toggle the visibility of the desktop icons, with no further work required. SendMessage(FindWindow(“Progman,” “Program Manager”), WM-COMMAND, O×7402,O). When using this method, no visual-transition may be possible. Moreover, the ability to selectively-hide individual icons may not be available.

In an OEM-method (e.g., if the original creator of the desktop program/environment itself were to implement this feature—instead of being implemented as a 3rd party add-on—then the following simplified steps could be taken to implement this functionality. In order to perform the quick-hide features of hiding desktop icons, several steps may be unnecessary if this functionality were implemented directly by those controlling the desktop program environment. For example, if Microsoft® or Apple® were to implement the functionality into their operating systems, or some other 3rd party OEM's would implement the functionality in to their 3rd party desktop environment software, they could modify the drawing procedure of the icons directly, rather than hooking-in to intercept paint messages and move icons around, etc.

For example, potential steps that Microsoft, Apple, or any other desktop vendor/platform (such as Linux) may take to modify their desktops to perform this feature include tracking of the “visuals”. The “visibility” for each icon may be tracked. This is used when drawing a specific icon, because the drawing is performed according to the visibility level associated with that icon.

In another example, the OEM's may modify the interaction of their software. For example, when a double-click (or other singular-motion trigger) is received, trigger a transition for all involved icons to toggle their visibility. In another example, when a click is received, do not process that click if it is related to an icon that is hidden. These are but a few of many ways an OEM could implement quick-hide features in to their own desktop software similar to the toggling and quick-hide flow-diagrams described above.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. The embodiments should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A method comprising:
displaying a desktop for a computing system, the desktop having icons;
in response to a single action being performed, making the icons non-viewable on the desktop when the icons are initially viewable and making the icons viewable on the desktop when the icons are initially non-viewable.

2. The method of claim 1, further comprising:
intercepting messages internal to the computing system to determine whether the single action is being performed.

3. The method of claim 1, further comprising:
determining a current position of a cursor within the desktop; and
triggering an event that indicates the single action is being performed when the current position is not over an icon on the desktop.

4. The method of claim 1, wherein making the icons non-viewable comprises adjusting the transparency of the icon from viewable to non-viewable.

5. The method of claim 4, further comprising:
removing the icons from the desktop when the icons are non-viewable.

6. The method of claim 1, wherein the single action being performed involves a user's finger interfacing with the desktop by a touch-screen.

7. The method of claim 1, wherein the single action being performed involves a mouse interfacing with the desktop.

8. The method of claim 1, further comprising:
moving the icons off of the desktop to make the icons non-viewable; and
moving the icons onto the desktop to make the icons viewable.

9. A computer system comprising:
a storage device having desktop software of the type capable of displaying a desktop on a screen where the desktop uses icons representing computer programs;
a processor interrelated with the storage device and being capable of running the desktop software;
a screen interrelated with the processor and being capable of displaying the desktop software and the icons;
an icon toggling input device interrelated with the processor for manipulating the desktop software; and
icon toggling software interrelated with the desktop software and being adapted to hide at least one of the icons in response to an input from the icon toggling input device.

10. The computer system of claim 9 wherein the icon toggling input device is a mouse and the input is a double click on a blank space on the screen.

11. The computer system of claim 9 wherein the icon toggling input device is at least one predetermined key on a keyboard, and the input is a keystroke of the key.

12. The computer system of claim 9 wherein the icon toggling input device includes one of:
a touch on a touch-screen;
activating a specific corner of the screen;
activating a specific edge of the screen;
activating a specific target on the screen;
the passing of a predetermined amount of time; and
a prolonged pressing of a key.

13. A method for using a mouse to manipulate computer desktop icons to temporarily hide them on the desktop, the method including the steps of:
manipulating the mouse to locate the cursor over blank space on the desktop;
manipulating the mouse to send a first input to the computer;
processing the first input with the computer; and
thereby causing the computer to hide the icon from the desktop.

14. The method of claim 13 further including the steps of manipulating the mouse to send a second input to the computer; processing the second input with the computer; and thereby causing the computer to make the icon re-appear on the desktop.

15. The method of claim 14 wherein the first and second inputs include one of: a mouse double-click, pressing at least one predetermined key; a gesture on a touch-screen; activating a specific corner of the screen; activating a specific edge of the screen; activating a specific target 20 on the screen; the passing of a predetermined amount of time; and a prolonged pressing of a key.

16. A method for using an input device to manipulate computer desktop icons to temporarily hide them on the desktop, the method including the steps of:
manipulating an input device to send a first input to the computer;
processing the first input with the computer; and
thereby causing the computer to hide the icon from the desktop.

17. The method of claim 16 further including the steps of manipulating the input device to send a second input to the computer; processing the second input with the computer; and thereby causing the computer to make the icon re-appear on the desktop.

18. The method of claim 16 wherein the step of causing the computer to hide the icon includes the step of removing the icon from the desktop and storing its position on the desktop for restoring later.

19. The method of claim 17 where the step of causing the computer to make the icon re-appear on the desktop includes restoring the position of the icon on the desktop.

20. The method of claim 17 wherein the first and second inputs include one of: a mouse double-click, pressing at least one predetermined key; a gesture on a touch-screen; activating a specific corner of the screen; activating a specific edge of the screen; activating a specific target on the screen; the passing of a predetermined amount of time; and a prolonged pressing of a key.
